(19) United States
(12) Patent Application Publication
(10) Pub. No.: US 2008/0253451 A1
(43) Pub. Date: Oct. 16, 2008

(54) Methods for real-time monitoring time reference in decoding systems

(75) Inventor: Te- Chi Hsiao, Hsinchu City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Media Tek Inc.

(21) Appl. No.: 11/787,173

(22) Filed: Apr. 13, 2007

(51) Int. Cl. H04B 1/66

(52) U.S. Cl. 375/240.12; 375/E07.125

(57) ABSTRACT

A method for real-time monitoring time related information in a bitstream by employing a prediction model is disclosed. When a bitstream is inputted to an decoding system, the bitstream having a series of embedded time references is decoded; a current time reference of the bitstream is sequentially supplied to a prediction model in real-time to generate an estimate time reference; determine whether the next time reference is valid based on the estimate time reference; and if the next time reference is determined as invalid, the frame associated with the next time reference is dropped from the bitstream, or the next time reference is corrected. Consequently, the timing of the bitstream is constantly monitored to prevent errors caused by incorrect timing information carried by the bitstream.

### BACKGROUND OF THE INVENTION

1. Field of the Invention

The invention relates to methods for monitoring time related information in real time and, more particularly, the invention employs a prediction model to generate an estimate for determining whether the next time reference is valid in a decoding system.

2. Description of the Prior Art

As schemes for recording and transferring a vast amount of picture and voice information as digital data, encoding systems, such as the MPEG (Moving Picture Experts Group) system, have been established and become international standards of encoding, such as the ISO/IEC 11172 and ISO/IEC 13818. Those systems are used as encoding systems for digital satellite broadcasting, DVD and so forth.

The MPEG system is explained below as one example. ISO/IEC 13818 (hereinafter referred to as “MPEG-2”) includes ISO/EEC 13818-1 (hereinafter called “system standard”), ISO/EEC 13818-2 (hereinafter called “video standard”) and ISO/EEC 13818-3 (hereinafter called “audio standard”). A data stream complied with the video standard and a data stream complied with the audio standard are multiplexed according to the system standard. According to the video standard and audio standard, picture and voice information are structured according to their encoding units and are detected by specific start codes and synchronization data.

At the time of multiplexing the aforementioned data streams, each of the streams that conforms to the video standard and the audio standard is segmented into data blocks, and headers are added to the data blocks to produce packets, and the data streams are multiplexed packet by packet. A packet consists of a header and a payload. Recorded in the header are information for video and audio synchronization and flags indicating the characteristic of data. A data stream of video, audio or the like is recorded in the payload. MPEG-2 packets include a pack, a PES (Packetized Elementary Stream) packet, and a TS (Transport Stream) packet. As a data stream is divided into packets of an adequate length before being multiplexed, recording, transfer and reproduction of data can be performed efficiently. Time information, namely SCR (System Clock Reference) in DVD and PCR (Program Clock Reference) in DVB-T, recorded in the header is used as a read time for a buffer by the decoder and as information for synchronization of clocks for the encoder and decoder. Time information, such as a PTS (Presentation Time Stamp) and DTS (Decoding Time Stamp), is used as information for synchronization of video playback and audio playback. Based on the playback time information, the decoder reproduces streams of video, audio and so forth in synchronism with each other.

However, in some cases, the aforesaid time information may be incorrect due to external interference or noise. For example, DVB-T is an erroneous environment with unpredicted distortion. In MPEG system, the bitstream comprising video and/or audio streams will utilize the time information to define the decode time or display time. Furthermore, not only video and/or audio streams but also the MPEG system needs to follow the time information. Once the MPEG system decodes the bitstream and retrieves incorrect time information, the bitstream will be decoded and displayed in the wrong way.

### SUMMARY OF THE INVENTION

A method employs a prediction model to monitor timing information carried by a bitstream in real time.

According to an embodiment, when a bitstream is provided to a decoding system, the method comprises decoding the bitstream having a series of embedded time reference, sequentially supplying a current time reference to a prediction model in real time to generate an estimate, and comparing a next time reference with the estimate to determine whether the next time reference is valid.

In some embodiments, if the difference between the next time reference and the estimate is larger than a threshold, the frame associated with the next time reference will be dropped from the bitstream, wherein the threshold is determined based on practical application.

The method is also applicable to calculate an estimate for the current time reference by supplying a previous time reference to the prediction model. The comparison between the estimate and the current time reference is used to determine whether the current time reference is valid.

The advantage and spirit of the invention may be understood by the following recitations together with the appended drawings.

### BRIEF DESCRIPTION OF THE APPENDED DRAWINGS

FIG. 1 is a flowchart illustrating the method for real-time monitoring time reference carried in a bitstream in a decoding system.

FIG. 2 is a schematic diagram illustrating the operation of Kalman filter.

### DETAILED DESCRIPTION OF THE INVENTION

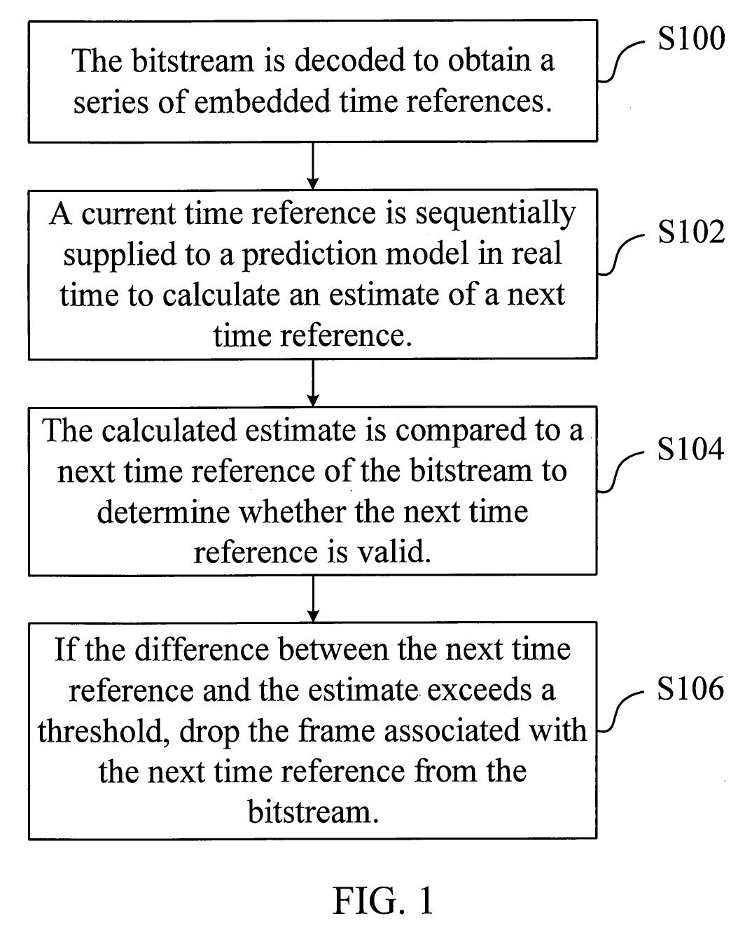

Referring to FIG. 1, FIG. 1 is a flowchart illustrating the method for real-time monitoring time references transmitted in a bitstream. In this embodiment, an estimate of time reference is calculated in real time and is used to check the validity of an incoming time reference extracted from the bitstream. When a bitstream coded in compliance with an MPEG standard is inputted to an MPEG decoding system, the bitstream is first decoded by a parser to obtain a series of embedded time references (step S100 in FIG. 1). The time reference may be system clock reference (SCR) in DVD systems or program clock reference (PCR) in DVB-T systems. In some other embodiments, the time reference may be presentation timestamp (PTS) or display timestamp (DTS) carried by video and audio bitstreams. In step S 102, a current time reference is sequentially supplied to a prediction model in real time to calculate an estimate of a next time reference. In step S104, the calculated estimate is compared to a next time reference of the bitstream to determine whether the next time reference is valid. In this embodiment, if the difference between the next time reference and the estimate exceeds a threshold, step S106 is performed to drop the frame associated with the next time reference from the bitstream, wherein the threshold is determined based on practical application.

In this embodiment, the prediction model is implemented using a software algorithm. The prediction model is preferably but not limited to a Kalman filter.

In some other embodiments, instead of estimating the next time reference, the current time reference can be estimated by supplying a previous time reference to the prediction model in real time.

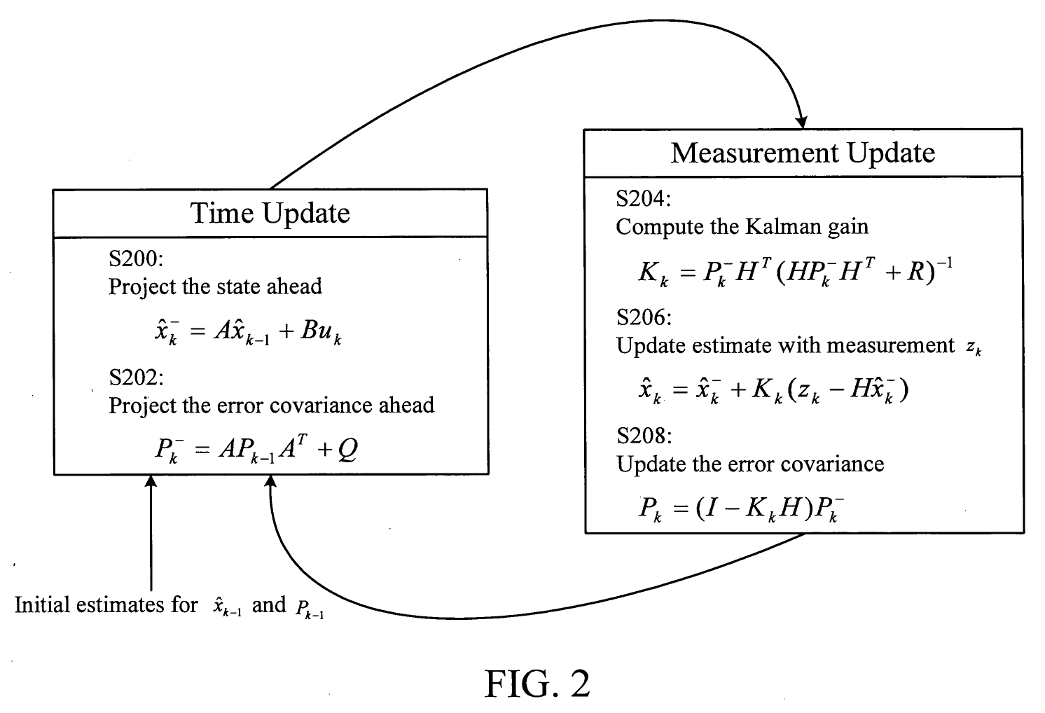

Referring to FIG. 2, FIG. 2 is a schematic diagram illustrating the operation of Kalman filter. The Kalman filter is a popular statistics estimation tool. As shown in FIG. 2, there are two sets of equations; one is for time update and the other is for measurement update. Equations for time update estimate a succeeding state and error covariance based on the current state and error covariance. Equations for measurement update compute a Kalman gain for correcting the estimated state and the error covariance with an actual measurement. In those equations shown in FIG. 2, \hat{x}ₖ⁻ represents a state vector as a priori state estimate at step k, and \hat{x}ₖ is a posteriori state estimate. Pₖ is a posteriori estimate of the error covariance and Pₖ⁻ is a priori estimate of the error covariance. zₖ is the measurement vector. H is the transformation matrix between zₖ and \hat{x}ₖ⁻. A is the state transition matrix. Kₖ represents the Kalman gain. B is the weight matrix of the control input. uₖ is the control input. R and Q are the variances of the measurement noise and the process noise, respectively.

As shown in FIG. 2, determination of an estimate of the time reference in real time uses a recursive process comprising the steps of:

Step S200: computing an estimate time reference \hat{x}ₖ⁻ based on an estimate of a preceding time reference \hat{x}ₖ₋₁;

Step S202: computing an error covariance Pₖ⁻ based on a preceding error covariance Pₖ₋₁;

Step S204: computing a Kalman gain Kₖ based on the error covariance Pₖ⁻;

Step S206: updating the estimate time reference \hat{x}ₖ⁻ to derive \hat{x}ₖ based on the Kalman gain Kₖ, and a time reference zₖ detected from the bitstream; and

Step S208: updating an error covariance Pₖ⁻ to derive Pₖ based on the Kalman gain Kₖ.

The Kalman gain Kₖ decreases if error increases, so the error has a smaller impact to the estimate time reference \hat{x}ₖ. In order to acquire more accurate initial estimates, the initial estimates may be computed by measurements retrieved from a longer period of time.

Furthermore, the bitstream mentioned in the above may comprise a video stream, an audio stream, or both video and audio streams.

Compared to the prior art, the invention employs a prediction model, such as a Kalman filter, to generate an estimate time reference based on time reference detected from the bitstream, and then compares a next time reference with the estimate time reference to determine whether the next time reference is valid. An embodiment of determining whether the next time reference is valid is to compare the difference between the next time reference and the estimate time reference with a threshold, if the difference is greater than the threshold, the next time reference is deemed to be invalid. Once the next time reference is determined as invalid, the erroneous time reference is dropped or corrected, or in some embodiments, the frame associated with the erroneous time reference will be dropped from the bitstream. In some embodiments, the next time reference is replaced by the estimate time reference. Consequently, the time information of the bitstream is continuously being monitored to prevent erroneous time information affects the performance of the decoding system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for real-time monitoring time reference in a decoding system, comprising the steps of:
decoding a bitstream having a series of embedded time references;
sequentially supplying a current time reference of the bitstream to a prediction model to generate an estimate time reference; and
comparing a next time reference with the estimate time reference to determine whether the next time reference is valid.

2. The method of claim 1, wherein the bitstream is coded in compliance with an MPEG standard.

3. The method of claim 1, wherein the prediction model is implemented using a software algorithm.

4. The method of claim 1, wherein the prediction model is a Kalman filter.

5. The method of claim 4, wherein determination of the estimate time reference employs a recursive process comprising the steps of:
computing the estimate time reference based on an estimate of a preceding time reference;
computing an error covariance based on a preceding error covariance;
computing a Kalman gain based on the error covariance;
updating the estimate time reference based on the Kalman gain, and a time reference detected from the bitstream; and
updating the error covariance based on the Kalman gain.

6. The method of claim 1, further comprising the step of dropping the frame associated with the next time reference from the bitstream if the next time reference is determined as invalid.

7. The method of claim 1, further comprising the step of dropping the next time reference if the next time reference is determined as invalid.

8. The method of claim 1, further comprising the step of replacing the next time reference with the estimate time reference if the next time reference is determined as invalid.

9. The method of claim 1, wherein the step of determining whether the next time reference is valid comprises comparing a difference between the next time reference and the estimate time reference, and determining the next time reference is invalid if the difference is greater than a threshold.

10. The method of claim 1, wherein the bitstream comprises a video stream, an audio stream, or both video and audio streams.

11. The method of claim 1, wherein the time reference is one selected from the group consisting of system clock reference (SCR), program clock reference (PCR), presentation time stamp (PTS), and decoding time stamp (DTS).
